(19) United States
(12) Patent Application Publication
(10) Pub. No.: US 2014/0224691 A1
(43) Pub. Date: Aug. 14, 2014

(54) FILING SYSTEM FOR COMMUNICATION CARDS

(71) Applicant: KAREN SADLER, Homer Glen, IL (US)

(72) Inventor: KAREN SADLER, Homer Glen, IL (US)

(21) Appl. No.: 13/766,127

(22) Filed: Feb. 13, 2013

(51) Int. Cl. B42F 7/14; B42F 21/02

(52) U.S. Cl. CPC B42F 7/145; B42F 21/02
USPC 206/425; 229/67.4

(57) ABSTRACT

A filing system comprising: a card filing box with a base and a plurality of wall members extending therefrom; a plurality of tabbed dividers, each having a tab extending from the tabbed divider; wherein each of the plurality of tabbed dividers is provided with a pouch wherein the pouch on each of the plurality of tabbed dividers has a mouth that provides access to the enclosed region of the pouch; and a closure mechanism disposed on the mouth of the pouch; wherein the pouch is configured to accept picture communication cards; wherein the closure mechanism has an open position and a closed position; and wherein at least one of the plurality of tabbed dividers is removably disposable within the card filing box.

### TECHNICAL FIELD

The present disclosure relates to a filing system, in particular, a filing system for picture communication cards that allows users to more easily find the cards they are seeking.

### BACKGROUND

Picture communication cards are a popular system of non-verbal communications. The communication cards may each have a picture or drawing of an object, action, symbol, or concept. Written above the picture may be a word describing the picture. Picture communication cards are widely used in school and social settings with people, often children, who are non-verbal or have limited verbal skills, or who have language processing difficulties. Picture communication cards may also be used when teaching multi-lingual students, especially those for whom English is not their native tongue. Using picture communication cards allows a person with communication difficulties to communicate with others, and others to communicate with them.

The communication cards are often used in schools or other educational settings, and may serve as the primary means of communication with some students. The communication cards may be used to inform a student with limited verbal skills about upcoming events in their daily schedule, or to try to teach them different concepts. The person with the communication difficulties may use communication cards to signify his or her needs or wants. For example, pointing to a picture communication card illustrating a glass of milk may allow the person with communication difficulties to signal a caregiver that he or she wants a glass of milk. Similarly, when a parent, teacher, or other caregiver indicates a picture of food, often accompanying the pointing with a verbal explanation, the child may understand that it is meal time or snack time, and may begin to associate spoken words with their associated concepts. In this way, children with communication difficulties may learn to use words to communicate with others.

Since so many words and concepts are used in daily communication, caregivers, especially those who work with children in an educational setting, may have hundreds of different picture communication cards covering a variety of situations and subjects. In a school or educational setting, teachers or caregivers may have multiple copies of many of the communication cards, thereby allowing them to have separate communication cards available for each student. Providing sufficient duplicate cards allows each student to, for example, have a daily schedule on his or her desk.

In a school setting, there may be communication cards for different subjects, seasons, holidays, days of the week, colors, numbers, foods, and different activities and, depending on the severity of the disability of the person with the communication difficulty, possibly even cards for different steps for commonly performed tasks. For example, to instruct a child to wash her hands, the caregiver may need one card for wetting the hands, one for applying soap, one for scrubbing the hands, one for rinsing, and one for drying the hands. Thus, a teacher or caregiver may have hundreds of different picture cards on a variety of different topics and themes.

Often, in use, the selected communication cards will be placed on a backing that allows the placement of multiple communication cards. For example, a student's schedule may be laid out along a length of fabric or other material. In some cases, the fabric or other material may have a length of hook and loop fastener along it or discrete bits of hook and loop fastener positioned on it. A mating portion of hook and loop fastener may be disposed on the back of each communication card, thereby allowing the communication cards to be fastened to the fabric or other material. Alternatively, a length of fabric or other material may have multiple pockets for each individual communication card with transparent fronts, so that when a card is placed in the pocket, the picture can be seen.

Teachers or caregivers may wish to find and arrange the communication cards they anticipate will be used prior to needing them; for example, they may lay out schedules for each student prior to the arrival of the students. Communication cards may commonly be stored on pages in binders. The pages may have strips of hook and loop fastener along the pages, allowing the communication cards to be fastened to the pages. Users may need to search through several thick binders that may each have close to a hundred pages or more to find the picture communication cards desired for a specific lesson. Alternatively, the picture communication cards may be stored in transparent sealable bags, and each sealable bag may be labeled with a different topic, such as “Schedule” or “Seasons.” The sealable bags may be stored in boxes. Users must search through the boxes to find the appropriate sealable bags, and then go through each of the desired sealable bags to find the communication cards they want to use that day. Finding communication cards stored using either of these systems may be time-consuming and cumbersome.

### SUMMARY

A filing system for communication cards is disclosed. The filing system consists of a series of tabbed dividers, at least some of which have a reclosable pouch. The tabbed dividers fit into a filing box. The tabbed dividers may have a dot of glue or adhesive, or a small piece of hook and loop fastener, on the tab, to allow a communication card or other indicator to be attached to the tab, thereby indicating what cards are filed within the pouch. Section dividers may be used to allow organization of communication cards within box.

### BRIEF DESCRIPTION OF THE DRAWINGS

FIG. 1 is a filing system for picture communication cards;

FIG. 2 is a tabbed divider for the filing system of FIG. 1;

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

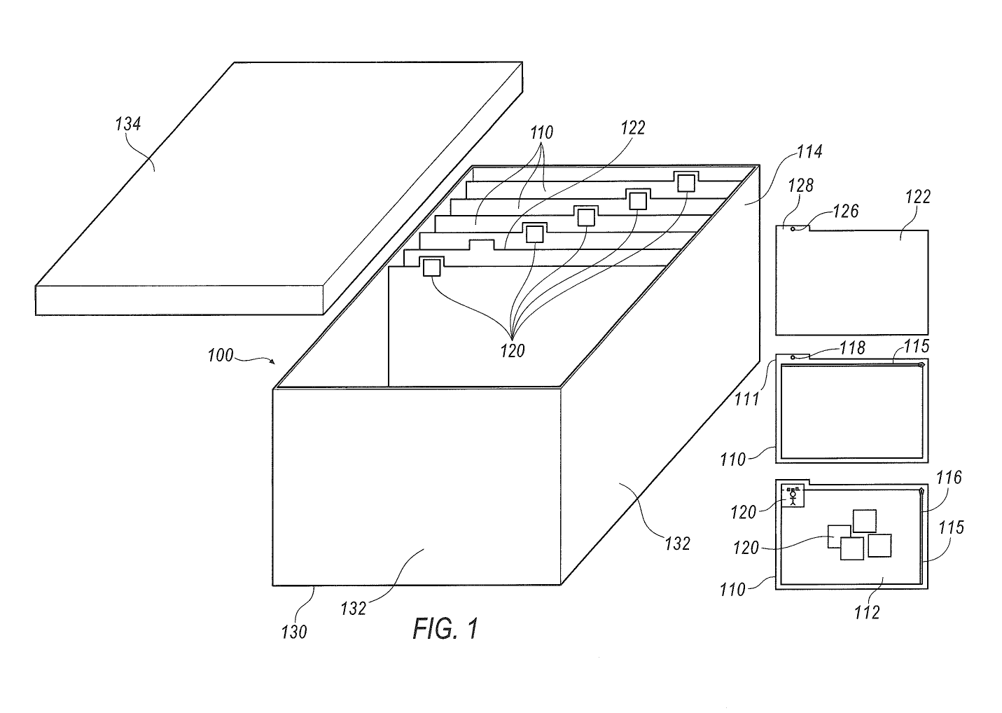

A filing system for communication cards allows for the efficient and organized storage of communication cards. As shown in FIG. 1, the filing system 100 may comprise a plurality of tabbed dividers 110 with tabs 111, at least some of the tabbed dividers having a pouch 112, and a card filing box 114 in which the tabbed dividers 110 fit in an organized manner. The tabbed dividers 110 may be selectively placed within the card filing box, and as such some of the tabbed dividers 110 illustrated in FIG. 1 are shown within the card filing box 114, and other tabbed dividers 110 are shown removed from the card filing box 114. A closure mechanism 116 may allow the pouches 112 of the dividers 110 to be selectively closed. The tabbed dividers 110 may have an adhesive dot 118 or a piece of hook and loop fastener secured to tab 111 to allow a communication card 120 or other indicator to be secured to tab 111 to indicate the contents of the pouch 112 of a tabbed divider 110. The tabbed dividers 110 are sized and configured to allow a plurality of tabbed dividers 110 to fit within a card filing box 114. Section dividers 122 may be used to allow the organization of tabbed dividers 110 with pouches 112 within the card filing box 114.

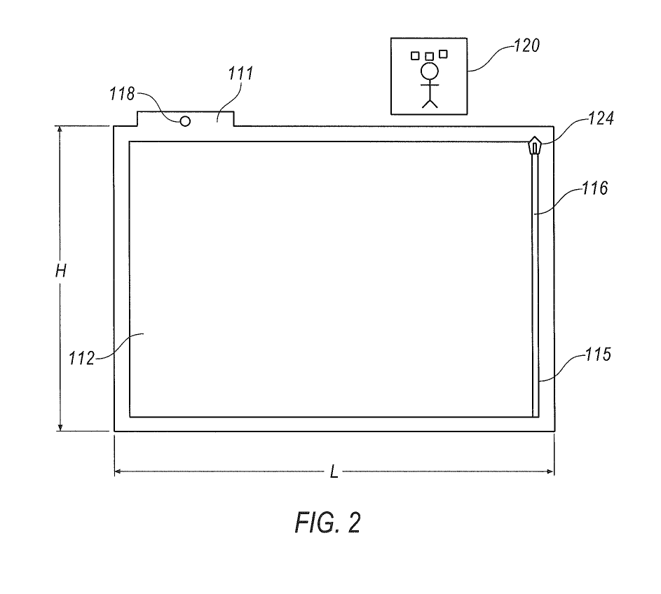

Referring to FIG. 2, an exemplary tabbed divider 110 may have a generally rectangular shape with a length “L” and a height “H”, and with two sides, a top and a bottom. Alternatively, tabbed divider 110 may be generally square, with the length being approximately equal to the height (not shown). Tabbed dividers 110 may be formed of heavy paper, card stock, paperboard or other suitable material, merely as examples. In one exemplary illustration, suitable materials for tabbed dividers may be sturdy but have some flexibility. A tab 111 may extend outward from the length of tabbed divider 110 and be co-planar with tabbed divider 110.

A pouch 112 defining an enclosed region may be secured to the face of tabbed divider 110. Pouch 112 may be formed of two opposing panels, each panel having four edges. The panels may be either generally rectangular or generally square, each having two side edges, one top edge, and one bottom edge. The panels may be joined together at three of the edges to define the enclosed region. Pouch 112 may have a mouth 115 that provides access to the enclosed region. Mouth 115 may extend along the top edge or a side edge.

Alternatively, the pouch 112 may be defined between a portion of face of tabbed divider 110 and a panel joined to tabbed divider 110 to define an enclosed region. The panel may be either generally rectangular or generally square, and the dimensions of the panel may generally coincide with the dimensions of tabbed divider 110. The panel may have two side edges, one top edge, and one bottom edge. The panel may be joined to tabbed divider 110 at three of the four edges. Pouch 112 may have a mouth 115 that provides access to the enclosed region. Mouth 115 may extend along a side edge or the top edge.

Tabbed divider 110 may have a pre-adhered double-sided adhesive dot 118 attached to tab 111. The first side of adhesive dot 118 may be adhered to tab 111. Second side of pre-adhered adhesive dot 118 may be initially covered with a removable release paper to prevent adhesive dot 118 from adhering to undesired surfaces while retaining the ability to adhere until the user is ready to attach a communication card 120 or other indicator to adhesive dot 118. When user is ready to attach a communication card 120 or other indicator to tab 111, removable release paper may be removed from second side of adhesive dot 118, thereby allowing a communication card 120 or other indicator to be secured to tab 111. Alternatively, tabbed divider 110 may have a hook and loop fastener adhered to tab 111, to allow a communication card 120 with a mating hook and loop fastener to be secured to tab 111.

A picture communication card 120 may be attached to the second side of pre-adhered adhesive dot 118 to indicate the contents of the pouch 112 of the tabbed divider 110. As shown in FIG. 3, picture communication card 120 may display a picture, drawing or symbol and, above that, may have a word describing the picture, drawing or symbol. When attached to tab 111, the top of the card 120, and the associated words, may coincide with the top of tab 111, thereby allowing the words to be read when tabbed dividers 110 are filed in card filing box 114.

Pouch 112 may be defined between one face of tabbed divider 110 and a panel secured to face of tabbed divider 110, thereby defining an enclosed region with a mouth 115 that provides access to the enclosed region. Panel may be of a transparent material. Alternatively, pouch 112 may be made of two opposing panels, joined together to define an enclosed region with a mouth 115 that provides access to the enclosed region, where one panel of pouch 112 may be secured to the face of tabbed divider 110. Pouch 112 may be secured to tabbed divider 110 with an adhesive, or with any other appropriate means of attachment. One or both panels of pouch 112 may be of a transparent material. A zippered closure or a resealable closure mechanism 116 may be provided along mouth 115, to allow pouch 112 to be closed.

Pouch 112 may correspond to size and shape of tabbed dividers 110, being of approximately the same length and height as the length and height of tabbed divider 110. If tabbed dividers 110 are generally rectangular, pouch 112 may be generally rectangular. Similarly, if tabbed dividers 110 are generally square, pouch 112 may be generally square. Pouch 112 may be affixed to tabbed divider 110 with the length of pouch 112 disposed along the length of tabbed divider 110 and the height of pouch 112 disposed along the height of tabbed divider 110.

Pouch 112 is sufficiently flexible to allow users to open pouch, insert communication cards 120 into pouch, and remove communication cards 120 from pouch. Pouch 112 may be of a transparent material to allow users to visually inspect the contents of the pouch to ascertain whether the desired communication card or cards 120 are within pouch 112.

Mouth 115 of pouch 112 may extend along height H of pouch 112. Alternatively, mouth 115 may extend along length L of pouch 112, especially along top of pouch 112. Mouth 115 of pouch 112 is long enough to allow easy insertion and removal of picture communication cards 120. Picture communication cards 120 typically come in two standard sizes: one inch by one inch (1×1) or two inches by two inches (2×2). Custom communication card sizes are also available, and may include cards approximately four inches by four inches (4×4) or larger, or non-square cards. The larger communication cards may be used when the student is far enough from the person holding the card that a smaller card would not be easily visible. Pouch 112 may be large enough to allow communication cards that are up to 4.5×7 inches to fit in the pouch. Larger tabbed dividers 110 and larger card filing boxes may be used to accommodate communication cards larger than 4.5×7 inches if desired.

A closure mechanism 116 may be disposed on mouth 115 of pouch 112. Closure mechanism 116 may be a zippered closure, for example. Zippered closure may have a slide 124 for opening and closing zippered closure. Alternatively, closure mechanism 116 may have two facing mating profiles that, when pressed together, interlock with one another, and users may close the pouch 112 by running a finger along the length of the closure mechanism 116 pressing the two mating profiles together, thereby causing mating profiles to interlock with one another. Other closure mechanisms may be used, such as securing mating portions of hook and loop fasteners on opposing surfaces of pouch 112 along mouth 115, or extending a flap from one side of pouch 112 adjacent mouth 115 wherein the flap may fold over mouth 115 and is securable to surface of pouch 112. Closure mechanism 116 may have an open position and a closed position. When closure mechanism 116 is in the closed position, closure mechanism secures mouth 115 in a closed position. When closure is in the open position, users may access the interior region of pouch 112 and insert and remove picture communication cards 120 from the interior region.

Pouches may be oriented on tabbed dividers 110 in such a way that some pouches may have a mouth 115 and/or closure mechanism 116 on a first side of the pouch 112, e.g., extending along the height H of pouch 112 on the left side of tabbed divider 110, while other pouches 112 may have mouth 115 and/or closure mechanism 116 on a second side of the pouch 112, e.g., the right side of tabbed divider 110 extending along the height H of pouch 112. Accordingly, if closure mechanisms are relatively thick in relation to tabbed dividers 110 such that they and extend a distance from tabbed divider 110, disposing closure mechanisms on different sides of tabbed divider 110, e.g., in an alternating fashion, may allow more tabbed dividers 110 to fit within card filing box 114.

Closure mechanism 116 may be positioned on the opposite side of the tabbed divider 110 from the tab 111. For example, tabbed dividers 110 with tabs on the right side of the tabbed divider may have closure mechanisms 116 on the left side. Positioning closure mechanism 116 along side of pouch 112 furthest away from tab 111 may generally allow users to operate closure mechanism 116 and access contents of pouch 112 without interfering with communication card 120 affixed to tab 111. Closure mechanism 116 may alternatively be disposed along length of pouch 112, especially along top of pouch 112.

The width of tabbed divider 110 may be approximately a multiple of the width of either a communication card or a tab. For example, tabbed divider 110 may be approximately four times wider than the width of tab 111. In this example, if a standard size tabbed divider 110, such as 5½ inches by 8½ inches, is used, the tabs may each be approximately two inches wide, resulting in four possible locations on each tabbed divider 110 for the tabs to be located so as not to partially or completely obscure the indicator attached to other tabs on other tabbed dividers 110 in card filing box 114. This allows tabs, with communication cards 120 or other indicator attached, to be staggered when a plurality of tabbed dividers 110 are stored or filed within card filing box 114 while still remaining easily visible to users, thereby allowing users to more quickly and easily find the desired communication card pouch 112.

Tab 111 may be generally the same width as a standard-sized picture communication card; i.e., either approximately one inch wide or approximately two inches wide. When using an 8.5 inch wide tabbed divider, this would allow either four or eight different possible tab locations, depending on the tab width used, that would allow communication cards 120 or other indicator on tab 111 to be visible without partially or completely obscuring one another as tabbed dividers 110 are stored in card filing box 114.

The tabs 111 may be used to indicate a theme or category of communication cards 120 that are contained within an associated pouch 112 of any given tabbed divider 110. For example, a user may secure picture a communication card 120 to an adhesive dot 118 on tab 111 to indicate a general theme or category associated with the tabbed divider 110. Picture communication card 120 may indicate the contents of pouch 112, e.g., the specific picture communication cards 120 within pouch 112, or the theme of picture communication cards 120 within pouch 112. For example, picture communication card 120 secured to tab 111 may have a picture of a tree and the word, “tree,” written above the picture. The associated pouch 112 may contain a plurality of picture communication cards 120, each showing a picture of a tree, with the word, “tree,” written above it. In another example, picture communication card 120 secured to tab 111 may have a picture of a face on it and the word, “face,” written above the picture. The associated pouch 112 may contain picture communication cards 120 associated with a face, e.g., cards 120 that depict, merely as examples, a nose, a mouth, and an eye.

Tabbed dividers without pouches may be used to divide card filing box 114 into sections. Tabbed section dividers 122 may be different colors from tabbed dividers with pouches to make them more visible to users. Like tabbed dividers with pouches, tabbed section dividers 122 may have double-sided adhesive dots 126 secured to tab 128. A removable release paper may initially be disposed over the exposed side of adhesive dot 126 to prevent adhesive dot from adhering to undesired surfaces while retaining the ability to adhere until the user is ready to attach a communication card 120 or other indicator to adhesive dot 126, thereby indicating the type of communication cards 120 stored within a section of the card filing box 114. Alternatively, tabbed section dividers 122 may have a hook and loop fastener secured to tab 128 to allow a communication card 120 with a mating hook and loop fastener to be secured to hook and loop fastener on tab 128. Another alternative may be to provide a writable surface on tab 128 of tabbed section dividers 122, thereby allowing users to write a brief description or otherwise indicate in writing the contents of the section of card filing box 114. Tabbed section dividers 122 may be used to separate a plurality of tabbed dividers 110 into different sections within card filing box 114. Tabbed dividers 110 within each section may share certain characteristics. For example, tabbed section divider 120 may have the word “objects” written on tab 128. Tabbed dividers 110 within that section of filing system 100 may include those in which picture communication cards 120 on tab 111 depict things such as crayons, books, and blocks, and in which each respective pouch 112 has disposed within it picture communication cards 120 depicting crayons, books and blocks.

Card filing box 114 may have a base 130 and wall members 132. Base 130 may be either rectangular or square. Wall members 132 extend in a generally perpendicular direction from base 130 to define a generally rectangular or square prism-shaped cavity between wall members 132 and base 130. Card filing box 114 may be slightly wider than the length of tabbed dividers 110, and wall members 132 may be slightly higher than the height of tabbed dividers. Card filing box 114 may be sufficiently long to allow the storage of many tabbed dividers 110 with pouches 112. In one exemplary illustration, the card filing box 114 is sufficiently long to allow the storage of forty or more tabbed dividers with pouches.

Card filing box 114 may have a lid 134. Lid 134 may be attached to a wall member 132 of card filing box 114, and may be removable from the wall members 132 to allow opening the card filing box 114. One end of lid 134 may alternatively be secured to and hinged with respect to one of the wall members 132. An opposite end of lid 134 may be selectively securable to an opposite wall member 132, thereby allowing opposite end of lid 134 to be secured in a closed position to card filing box 114. When lid 134 is in place on card filing box 114, multiple card filing boxes may be stacked together to provide organized storage for large numbers of picture communication cards 120.

To use the picture communication card filing system 100, users may store communication cards 120 within pouches 112 on tabbed dividers 110. A pouch 112 may hold communication cards 120 with different pictures or symbols on them, or all the communication cards within a pouch 112 may contain the same picture or symbol. If communication cards 120 with different pictures or symbols are in the same pouch 112, the communication cards may all be related to one another, such as communication cards showing different colors or different steps to be taken when performing a specific task. A communication card 120 or other indicator may be affixed to tab 111 to indicate the contents of the pouch 112 of tabbed divider 110. A resealable or zippered closure or other closure mechanism 116 may allow selective closure of pouch 112 and may serve to retain communication cards 120 within pouch 112.

Once communication cards 120 have been stored within a pouch 112 and mouth 115 of the pouch 112 has been closed, tabbed dividers 110 with pouches 112 may be filed in card filing box 114. A plurality of tabbed dividers 110 with pouches, all of which contain communication cards 120 that are related to one theme, subject, or activities, may be stored in the same card filing box 114. Tabbed section dividers 122 may be placed into card filing box 114 between groups of tabbed dividers with pouches in order to separate different categories of communication cards, such as different school subjects or themes, from one another.

To access and remove communication cards 120 from card filing box 114, user may locate a desired communication card 120 or other indicator affixed to a tab 111 on a tabbed divider 110 in card filing box 114. Once a user has located the desired communication card 120 or other indicator on a tab 111, user can remove the associated tabbed divider 110 with pouch 112 from card filing box 114 to access communication cards 120 within pouch 112. Moreover, transparent material of pouch 112 may further allow user to perform a quick visual inspection to confirm that the proper pouch 112 has been located, in addition to any identifying information provided by any indicator(s) or other identifying marks, e.g., positioned on the tabs 111. User may open closure mechanism 116 at mouth 115 of pouch 112 and remove the desired number of communication cards 120. User may then replace tabbed divider 110 with pouch 112 in its previous location within card filing box 114, or may leave tabbed divider 110 in its previous location but resting on its side rather than on its bottom, with mouth 115 and closure mechanism 116 on top, thereby functioning as a place saver. Using tabbed divider 110 as a place saver facilitates the return of communication cards 120 to pouch 112, as pouch 112 may be easily found. To return communication cards 120 to pouch 112, user locates the appropriate tabbed divider 110, opens closure mechanism 116 at mouth 115 of pouch 112, and reinserts communication cards 120 into pouch 112. User then may close closure mechanism 116 of pouch 112 and insert tabbed divider 110 with closed pouch 112 into the appropriate location in card filing box 114.

Using the picture communication card filing system 100, including card filing box 114 and tabbed dividers 110 with pouches 112, may enable users to more quickly and efficiently find the communication cards 120 they need to use, and allow users to quickly sort and classify communication cards 120. Storing the communication cards 120 in the filing system may also save space, as the communication cards 120 are neatly filed rather than being stored in binders or in bags within boxes.

Accordingly, it is to be understood that the above description is intended to be illustrative and not restrictive. Many embodiments and applications other than the examples provided would be upon reading the above description. It is anticipated and intended that future developments will occur in the arts discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A filing system comprising:
a card filing box with a base and a plurality of wall members extending therefrom;
a plurality of tabbed dividers, each having a tab extending from the tabbed divider; wherein each of the plurality of tabbed dividers is provided with a pouch comprised of two opposing panels, each panel having four edges, and wherein each of the opposing panels is one of generally rectangular and generally square, wherein the two opposing panels are joined together at three of the edges to define an enclosed region, wherein the pouch on each of the plurality of tabbed dividers has a mouth that provides access to the enclosed region of the pouch, and wherein the mouth is disposed on the fourth edge of the panels; and
a closure mechanism disposed on the mouth of the pouch;
wherein the pouch is configured to accept picture communication cards;
wherein the closure mechanism has an open position and a closed position;
wherein, when the closure mechanism is in the open position, the closure mechanism allows the insertion and removal of picture communication cards into the pouch through the mouth, and when the closure mechanism is in the closed position, picture communication cards are retained within the pouch;
wherein, when the closure mechanism is in a closed position, the closure mechanism secures the mouth in a closed position; and
wherein at least one of the plurality of tabbed dividers is removably disposable within the card filing box.

2. The filing system of claim 1, wherein each of the pouches is adhered to one of the plurality of tabbed dividers.

3. The filing system of claim 1, wherein the pouch on each of the plurality of the tabbed dividers is defined between one face of the tabbed divider and a panel secured to the face of the tabbed divider.

4. The filing system of claim 1, wherein at least one panel of each of the pouches is transparent.

5. The filing system of claim 1, further comprising an attachment mechanism disposed on each of the tabs.

6. The filing system of claim 5, wherein the attachment mechanism is an adhesive.

7. The filing system of claim 5, wherein a first picture communication card is selectively securable to the attachment mechanism, wherein at least one further picture communication card is disposed with the pouch, and wherein the first picture communication card identifies the contents of the pouch.

8. The filing system of claim 1, wherein two of the edges of each of the plurality of pouches are side edges, one edge is a top edge, and one edge is a bottom edge, and wherein the mouth is disposed on one of the side edges of the pouch.

9. The filing system of claim 1, wherein two of the edges of each of the plurality of pouches are side edges, one edge is a top edge, and one edge is a bottom edge, and wherein the mouth is disposed on the top edge of the pouch.

10. The filing system of claim 1, further comprising at least one tabbed divider, wherein the at least one tabbed section divider is disposed within the card filing box.

11. The filing system of claim 1, wherein the card filing box has a lid.

12. The filing system of claim 1, wherein the closure mechanism is a zippered closure mechanism.

13. The filing system of claim 12, wherein the zippered closure mechanism is provided with a slide for opening and closing the zippered closure mechanism.

14. A filing system comprising:
a card filing box with a base and a plurality of wall members extending therefrom;
a plurality of tabbed dividers, each having a tab extending from the tabbed divider; wherein each of the plurality of tabbed dividers is provided with a pouch comprised of two opposing panels, each panel having four edges, wherein each of the opposing panels is one of generally rectangular and generally square, wherein the two opposing panels are joined together at three of the edges to define an enclosed region, wherein the pouch on each of the plurality of tabbed dividers has a mouth that provides access to the enclosed region of the pouch, and wherein the mouth is disposed on the fourth edge of the panels; and
a closure mechanism disposed on the mouth of the pouch, wherein the closure mechanism is a zippered closure mechanism;
wherein each of the plurality of pouches has two side edges, a top edge, and a bottom edge;
wherein the mouth is disposed on one of the side edges of the pouch;
wherein at least one of the panels on each of the plurality of pouches is transparent;
wherein the pouch is configured to accept picture communication cards;
wherein the closure mechanism has an open position and a closed position;
wherein, when the closure mechanism is in the open position, the closure mechanism allows the insertion and removal of picture communication cards into the pouch through the mouth, and when the closure mechanism is in the closed position, picture communication cards are retained within the pouch;
wherein, when the closure mechanism is in a closed position, the closure mechanism secures the mouth in a closed position;
wherein at least one of the plurality of tabbed dividers is removably disposable within the card filing box;
wherein a picture communication card is selectively securable to an adhesive device on the tab; and
wherein the card filing box has a lid.

15. A tabbed divider comprising:
a tab extending from the tabbed divider; and
a pouch defined by two opposing panels, each panel having four edges, wherein each of the opposing panels is one of generally rectangular and generally square, wherein the two opposing panels are joined together at three of the edges to define an enclosed region, wherein the pouch has a mouth that provides access to the enclosed region, and wherein the mouth is disposed on the fourth edges of the panels; and
wherein a closure mechanism is disposed on the mouth of the pouch;
wherein, when the closure mechanism is in a closed position, the closure mechanism secures the mouth in a closed position; and
wherein the pouch is configured to accept a plurality of picture communication cards.

16. The tabbed divider of claim 15, wherein the closure mechanism is a zippered closure mechanism.

17. The tabbed divider of claim 15, wherein at least one of the opposing panels is transparent.

18. The tabbed divider of claim 15, wherein an adhesive is disposed on the tab.

19. The tabbed divider of claim 15, wherein the pouch has two side edges, a top edge, and a bottom edge, and wherein the mouth is disposed on one of the side edges of the pouch.
